(19) United States
(12) Patent Application Publication
(10) Pub. No.: US 2012/0317203 A1
(43) Pub. Date: Dec. 13, 2012

(54) Method and System for Business Peer Group Networking

(76) Inventor: Michael Hostetler, Cardiff, CA (US)

(21) Appl. No.: 13/567,766

(22) Filed: Aug. 6, 2012

Related U.S. Application Data
(63) Continuation of application No. 13/007,569, filed on Jan. 14, 2011, now abandoned.
(60) Provisional application No. 61/295,147, filed on Jan. 14, 2010.

(51) Int. Cl. G06F 15/16

(52) U.S. Cl. 709/204

(57) ABSTRACT

A business social network is provided employing a relational database associating members by their job and industry and individual research areas of interest determined topic deemed of interest by member input into provided graphical interfaced questions. Answers to posed questions regarding interest level and expertise level of respective members of each cluster are employed for grouping of members for webcasts, member searches for like-minded members, and for sending topic related polls to members most likely to answer based on their expertise and level interest in the topic.

This application is a continuing application to U.S. application Ser. No. 13/007,569 filed on Jan. 14, 2011, which claims priority to U.S. Provisional Application Ser. No. 61/295,147, filed on, Jan. 14, 2010 all of which are incorporated herein by reference in their respective entirety.

### FIELD OF INVENTION

The present invention relates generally to business networking communication amongst business peers. More particularly, the disclosed method and system relates to an online service which allows subscribing members, to join groups and interface and communicate with similarly situated peers from different businesses. The system employs a poll driven process to answer common questions and concerns of the subscribing members of one or a plurality of such groups of subscribers.

### BACKGROUND OF THE INVENTION

Social networking using the internet is arguably one of the biggest successes of the Internet over the past five years. Wildly popular networking sites, such as FACEBOOK, MYSPACE, and YOUTUBE, have risen to provide members world wide exposure for themselves to potential friends, dates, spouses, and unfortunately predators and unseemly individuals. Most such social networking sites offer subscribers the ability to upload their personal photos and information for display or just to be stored in their profile. Consequently, millions of user photos are currently stored on servers throughout the world and can be easily compared through a central provider to ascertain matches in appearance which may be of great interest to users.

In spite of this explosion of communication amongst individuals through social networking, on a professional level, especially where peers may be from different companies, and have commonality regarding problems, concerns, operations, and the like, little in the way of social networking is available. Many larger companies who may have thousands of employees, do not allow access to the social networking sites noted above for a number of reasons. First, conventional social networking sites are by their very nature personal rather than business oriented.

Consequently, employees accessing such sites can tend to dally during working hours, thereby reducing productivity. Additionally, such widely used personal social networking sites have the potential for viruses and major network security breaches when accessed from a business network. This is another reason they may be firewalled by large businesses.

However, many large and small businesses encourage employees in positions which are strictly managerial in nature, such as human resources and accounting, to interface with other such individuals regarding common issues and concerns in their departments. Even large companies who are competitors in the same field for the same customers, allow their managerial staff personnel to interface with peers in similar positions with their competitors.

The reason for encouraging such business interfacing between peers located at different companies, and even at competitors, is the commonality of many problems, operating issues, accounting issues, human resource issues and the like which exist in most businesses at the managerial and administrative level. The information regarding such managerial type departments and staff is not generally proprietary in nature, and because these businesses structurally have similar managerial departments, with each handling similar tasks, they all tend to have similar problems and concerns over time that must be dealt with.

Conventionally, individuals in these managerial areas of small and large companies do interact on an irregular basis. These individuals generally join local business and position related associations, or attend regional, national, and international conventions of like individuals who are members of associations of professionals and managerial associations related to their job functions. However, such meetings and conventions occur only a few times a year at best thereby limiting personal interaction amongst peer members. Additionally, travel has become ever more expensive in the last decade with heightened security checks yielding long lines and delays. Consequently, due to the cost, time, and inconvenience, travel to locations remote to the business headquarters or distant destinations where such business meetings may be held, is another limiting factor of personal business interactions amongst professional peers.

Social networking sites by nature are conventionally driven by one user contacting another or individual users contacting multiple users. However, such contacts are generally fleeting and are by email or by visits to a member's hosted webpage on the networking server.

Business meetings held by trade associations and the like for their member professionals generally have a main convention featuring a trade show and a few major speakers. Concurrently, such conventions and shows sponsor many smaller meetings, roundtables, and guest speakers, which are focused on various topics of common concern to the smaller groups attending the convention. Many times these smaller meetings will gather peers from different companies and competitors, to discuss a particular subject or problem of common concern to all such companies. These smaller meetings of peers with common questions and problems ascertain solutions during or after the meeting. The solutions provided to all are based on the input of the peer members who are experts in the field, or peer members who have addressed the issue or common question in the past with successful results.

Additionally, trade associations and consulting firms over the years have employed techniques where a process is provided for members of a group to advance questions from other members in the peer group, in order to benefit from the experience of others in the group who may have addressed the question or problem already. Typical approaches of this type of interaction include discussion boards and online polling. Unfortunately, discussion boards and online polling typically fail at delivering high quality answers in a timely manner to all interested members. It isn't uncommon for a question posted to a discussion board having a membership of thousands to generate only a few responses.

Associations have also provided polling where a multiple choice selection is presented to members which makes it easier for people to respond. This is because selecting the best answer from a list of options isn't as difficult as writing an answer to an open-ended question. Multiple choice polls therefor yield response rates which are higher. Some association poll-providers will also add comments, which increases the value of the information.

However, simply getting responses, doesn't mean the information in those responses is valuable to the group members. This is because most such poll providers do not exclude vendors and consultants from the group. Since vendors are trying to sell their products, and consultants who are trying to sell their services or those of others, the input provided is at best, biased. Further, other group members may be looking for employment and have different motives. Because these vendor and unemployed members have a profit motive, they are also the individuals most likely to respond to a propounded question. Thus, the answers submitted are skewed with the responses of biased members and information provided to other members in the group will be less than accurate at best. Further, while these responses may be extremely detailed, the quality of the responses is often poor since the responding party has an interest which is more about selling themselves, or selling some product or service, and not about providing an objective answer to the common question.

In order to provide an alternative to professional association meetings and conventions and the like, attended by like minded and situated business people, and online chat rooms and the like where business people may seek answers, a business related social networking site for peers' needs to provide some means to delineate and control discussion topics common to peer group members. Once so defined, the system also needs some means to elicit input and responses from individual member peers who are best positioned to answer respective questions of common concern in an unbiased fashion. These answers of would be best elicited from the members with the most expertise or experience to provide answers for review by others in the group.

Once a question of common peer concern has been answered, such a business peer networking site also needs to provide a means to distribute the findings of the group to the rest of the members not participating in the solution discussions.

Additionally, the peer group provider needs some means to limit the pool of peer member subscribers to similarly situated workers or professionals. This requires some means to prohibit participation by commercial members having a bias to their point of view because they are trying to sell something which distorts their answer.

An additional concern with conventional peer sites is communicating the common questions with polls. Such a site should have a means to direct a given question directly to the peer members who are discerned as able to provide valuable answers. Conventionally, a common approach is to send a question by email to a subset of the membership of peers in a group which may consist of thousands of members, and request a response. While this email solicitation improves the overall response rate, the difficulty arises in ascertaining which peer members have valuable answers, finding peer members who are likely to respond to the given question, and finding the right balance so that one peer member isn't so overwhelmed by requests for responses that they treat incoming requests as spam and delete them.

Another tactic being employed by polls of peers is to have the questioning member provide some context to their situation so that the member responding has a better idea for why the question is being asked. If better overall responses have been provided by having the response key, and the question reviewed and cleaned up by a professional moderator in order to increase the quality of the questions being asked and the response rate since the question, response keys, and context will be easier for members to understand.

These approaches, while not common, are currently in use by a number of research firms and have existed for many years. However, they fail to take into consideration the competency of responders, the interest level of responders, the grouping of responders to those similarly situated with a common affinity for the topic, and for their work related positions. Additionally, conventional providers fail to target outgoing questions to members having the most expertise and such members having a proclivity to actually respond.

Accordingly, there exists an unmet need for a system employing networked software adapted to the task, and server hardware configured to the task, to provide a business peer interaction networking site which groups peers by their commonality of position and their industry and each member's personal affinity. Such a system and method should provide a means to group individual member peers by commonality of factors such as company size, job position, or other common topics and work related issues. Such a site should limit such discerned groupings to reasonable numbers of such members with common affinity and positions, to thereby achieve answers to polls and advanced questions to the grouping which are germane to the grouping rather than including wide variances in individual positions and affinities of individuals found in groups with high numbers of members and which skew results.

Still further, such a system should first take into consideration, the competency of potential responders, their interest level, and their experience, for each question to be answered. Employing such criteria and using software adapted to the task, the system should thereafter employ a software directed means to direct questions and issues common to the peer group, so as to reach and be answered by those individuals in the grouping most qualified to answer.

Still further, such a system should provide means for web-enabled teleconferences to allow users to share perspectives on an issue or provide opportunities with others in a research area of interest.

In addition, such a system should provide a communication tool similar to a private email network, which would advantageously allows integration with a member's personal work email account for convenience.

### SUMMARY OF THE INVENTION

The present invention is directed to a networked system, employing software adapted to the task and running on a remotely accessible server, to provide an interface for business peers who are determined as similarly situated, and having common business managerial issues and concerns, to join up in groups. Software adapted to the task and accessible through a server, will provide users with viewable remote displays on screens. The displays will depict fields for text input which when captured, may be compared to a relational database of words to allow the software and system to determine which of the joining peer subscribers, are sufficiently related to others to be grouped. The comparison is based on commonality of business department, employed position, the company size of an individual member, and other data providing a means to catagorize groups of business peers, who are highly related in their job positions and functions.

Unlike conventional online sites which allow unlimited peer membership in groups, with no real determination of the user's position or motives, the disclosed system herein limits group membership of highly related peers, in similar employment positions, in similarly sized companies. While conventionally a group of thousands or millions will yield a high volume of responses, such conventionally available groups and chat rooms may also be so large so as to water down the clarity or value of the information in the responses yielded.

The system herein employing software adapted to the task, dictates a limited maximum size to each peer group of job or position related individuals. By limiting the groupings to smaller groups, members online and in person are capable of becoming familiar with other members on a personal and business basis. Similarly, questions and polls put to such limited size groups of highly related members, will provide an incentive for members to comment candidly and be motivated to respond because of a commitment to their peer group and their familiarity with members. Experimentation to date has determined that with a 1,500 membership peer group, polls posed to the group will yield 25 to 40 responses within three days. Because of the close association of the peer members as to their respective job, company position, and industry, and the familiarity between the members in the smaller group, a poll will yield meaningful results that exceed or are at least comparable to results from a much larger pool of members.

The system herein also takes into consideration numerous other factors which will drive high poll response rates, including the steps of:

Having a group of peer members or administrators review of proposed polls prior to distribution, as a means to assure the poll is properly structured to avoid confusion and yield answers on point;

Making sure that received peer response choices to the poll, need little interpretation and are therefor understood in seconds;

Taking care to assure that context and objectives of the question or problem are clearly stated for the poll;

Employing software adapted to the task to mine information gathered from and about respective individual peer group members, to discern a match of preferred responding individual peers to specific polls by interest or experience;

Employing email notifications to the chosen preferred responding individual peers in the peer group, requesting responses to subsequently communicated polls;

Employing the software to ensure the name of each requested responding peer and the respective peer's company name is displayed in a subject line in email, to gather their attention and help avoid spam filters;

Dispatching each email with hyperlinks as a means to provide chosen responders an ease of moving from the email to being able to respond to the poll and as a means to induce them to answer quickly;

Differentiating the website for poll responses from background indicia to assure responders see it on the display communicated to their remote screen;

Providing visibility to summary poll results to all members of a research area to encourage curiosity about seeing the detail results and comments for the poll; Implementing a requirement that pees respond, or a peer from the same member company responds before the peer (or peers from the same company) are authorized to view detail results and comments;

In some instances, providing a chosen responding peer, an instant display of poll results, once the responder has input their response;

Employing software to search poll results by keyword to ascertain any commonality or patterns in the total responses; and Employing separate follow-up polls as a means for quality control, to ascertain if the chosen responding peers liked the manner of the presentation of the poll and seeking for input comments.

Of course those skilled in the art will realize the steps may be reorganized and possibly repeated or other steps might be added and such is anticipated.

The system herein, by limiting group size to smaller numbers of individuals, each of whom are highly related as to job position, administrative section, company size, job responsibilities, or have other determined commonality characteristics, and employing the above factors to enhance both questions advanced and received responses, will provide members with an enhanced experience and provide each member of each grouping industry knowledge that is not skewed by members with an agenda. By specifically targeting polls and questions to peer members most qualified to answer, due to their background, education, experience, or research, high quality and constant responses are provided such that the group will benefit much more than in the current conventional sites with mega-sized groups with loose relationships.

In addition, the system provides means to segment users into classes of users such as in the current preferred mode “Observers” and “Subject Matter Experts” (SMEs). Briefly, members who complete a ranking of their experience and interest level, within a list of topics which define a research area, will be identified as a SME within that identified immediate research area. Self-reporting or a matching by a member of their personal experience and interest level in a research area, is herein referred to as a “Topic Match.” Further it is preferred that most if not all topics within a research area, are required to be rated by the respective members for a member to be classified as an SME within that research area.

Research area content is classified by topic, or list of topics. Content that matches members' experience or identified interest levels may be flagged for possible review by the member to aid in the self ranking process. Alternatively, while searching for content such as by keyword, matches by issues may be identified, with an SME member having visibility to see information about other members who have high or very high experience in a topic. In addition, matches with polls for specific topics, webcasts for specific topics, and shared documents for specific topics, may be made available to the member.

In addition to appearing in search results by topic, members who are SME's can view the names and summary profile information to search for peers who have high or very high experience, or high or very high interest in any of the topics that define a research area, herein referred to as a ‘Peer Match’. The member reviewing provided screens of information regarding a potential Peer Match, can also review provided basic profile information about an identified potential Peer Match member's company. In this fashion the member looking for a Peer Match can create context (for example, annual revenue, primary financial system, industry grouping, company name) and by selecting the abbreviated name (such as a format using the first name and first initial of the last name) can see a summary of the potential Peer Match member's profile details. In addition to the provided information about a potential Peer Match, the system provides the ability to send a potential Peer Match a message using a built-in email capability. This can be accomplished without disclosing the sending member's contact details such as their actual phone number or email address. Using the anonomizing email provided by the system, the peer-seeking member can send a message to the member targeted as a potential Peer Match, as an email to their business email account. The message has identification markers such that it is identified as a new message from another member of the peer network so that the message is not filtered to spam or viewed as a potential advertisement from an unknown source.

In addition, members are provided the ability to participate in web-enabled teleconferences, also referred to as webcasts, or peercasts, where one or more members are featured to the viewing members and share their perspectives on an issue or opportunity with others in a research area, to those other members who are interested in the topic or research area.

The system communicates updates to registered members using email or text or other communication. The updates include information regarding upcoming teleconferences. In addition to the information regarding topic and research area, and listing featured members participating in the teleconference, the communication can include communicated information providing potential attendee members with the ability to see which other members have already registered to attend the discussion by teleconference.

During the discussion itself, the session is professionally facilitated by members or moderators from the service provider, to encourage interaction and discussion between participants. Guidelines for these interactions are pre-established with rules, including; precluding any vendors or consultants from attending, and having participants precede comments during the session, with identifiers to other members of the member name and the name of the company the commenting member represents. Because all attendees of the teleconference have a visual listing communicated of the other members concurrently participating in the call or teleconference, it provides each respective member an easy means to track comments to the members providing them. With this ability to match comments to members providing them, other members are provided with a means to easily follow up with the other attendees based on their comments, or their known identity, after cessation of the call or teleconference, by referring to an attendee list.

Registrations of members participating in each teleconference or webcast are monitored by the service provider, to maintain the group at or below a predetermined maximum. For example teleconferences or video meetings with more than 200 likely attendees can be split into separate teleconferences, to create an atmosphere with less potential crossover of comments and input which thereby supports interaction and collaboration better than a larger group.

Entry to the teleconferences or webcast takes place in the specified section of the website, where concurrently the listing of attendees who are participating is maintained. At a defined time prior to the scheduled beginning of a teleconference, for instance thirty-minutes prior, the screen communicated with an option to “register” (or if registered already, to “unregister”) is replaced with a screen having an icon inferring a meeting entry, such as that of a door.

Employing a curser and mouse or other graphic interface choice combination, a selection on the provided icon, after the system identifies the member making the choice is registered, will provide the registered member with access to the teleconference or webcast window. It is from within the window that the member views the teleconference. Both audio and video may be communicated over the network such as the Internet to computers and/or smartphones of registered members, or participating members may call into a separate number solely for an audio feed. During the teleconference, all registered members are able to talk, ask questions, or interrupt at anytime.

After the webcast finishes, the recording of the webcast taken by the service provider, can be made available to member attendees, or to other members who were unable to attend the discussion but wished to.

When new members view the webcast, they will be listed in the roster of member “attendees.” Consequently, a webcast that has 80 registered attendees participating, for example, might after four months, show 96 member attendees listed, should 16 additional new members, who were not previously registered, view the recording. In addition, the service provider webcast recording presentation may be subsequently easily viewed by members at anytime after the webcast takes place.

Still further, the system additionally and preferably includes a built-in communication tool which operates much like a private email network. This portion of the system allows seamless integration of the emails sent through the system provider server, from other members, with a respective member's personal work email account. It is preferred that emails sent through the system provider email server, have a system identifier discernable by the receiving member, which identifies the email as being from or through the system provider. This same system identifier can be input into spam filters and virus filters to lessen or eliminate scanning and filtering of email.

The provided email system allows members to communicate quickly and easily with other members by selecting their name in a listing, such as webcast attendees, or from a search result, or by sending a response to an incoming email, without the sending member needing to type the recipient address. Thus when typing their message using a commercial email application, members need not worry about misaddressing response addresses from typographical errors when entering the recipients email address information. Thus members finding common interest with other members who attend a webcast or teleconference, can easily contact those members by selecting the identified member's listed name, which would be on the video screen and electronically communicated as a hotlink to fill in an email address which runs to and through the system provider email server.

Confusion amongst email recipients as to sending members, is reduced by preferably precluding members from using the system provided email for broadcast messaging. For example, the system email can require that members sending messages must do so one at a time. Precluding lists or multiple addresses thus prevents members from “spamming” others in the membership. Members will thus be more inclined to read mail from fellow members knowing that advertisers, and spamming are not possible in mail sent through the provider system.

When the message is received, the recipient member can view the communicated message as displayed and select an included html link for a receiving member to communicate a reply, within the system of email communication of the provider. Use of the provided html link by a replying member facilitates quick and easy communication. Because the system generated the email to a known user which was verified during sending, replying members using the html link, or automatically logged onto the system and provided a video page for sending response email. Thus members reading email from other members on work or home computer systems, can easily reply to the sending member, using the system provider email system, by selecting the provided html or hot text link in the received email without being bothered with having to a login to the system. This encourages interaction amongst members since they are aware incoming email is from the system provider and not spam or advertising, and because they can send email to another member in a response by simply choosing the included link in the received email which will automatically navigate to the system provider email system.

In large corporations who's employees typically make up a good percentage of the system membership, it's typical for members to receive hundreds of email messages a day. Many of these received emails are unsolicited and many require filtering to remove spam, viruses, advertising, and to allow a receiving member at work, to have enough time to respond to messages which actually require attention.

The system herein, by providing a system identifier of the source of the incoming email, and by not displaying email address or phone numbers of sending members, and by employing the system provider email server, provides better security to members especially for sensitive information. Emails from the system can be easily authorized to circumvent corporate filters and virus scanners because incoming messages are identified as being from a corporate-authorised system provider, where both parties are members and where communication is encouraged by the company between such peers.

In addition to easy circumventing of spam and other email filters of large companies, the messages sent are more likely to be noticed by receiving members and thereafter responded to. This is because the incoming messages are sent through the system provider with the system identifier discernable by the receiving party. The receiving member thus knows the incoming message is most likely are from a sought, chosen, or current peer, with whom they wish to communicate.

Absent the sender system identifier providing an easy means to identify incoming messages as being sent by the system provider email, the member would view the message as a random message from someone they don't know at a company name that they may not recognize. Further, such unidentifiable messages are more likely to be filtered out as spam, be ignored, or be deleted without giving it the attention that is warranted.

With respect to the above description, before explaining at least one preferred embodiment of the herein disclosed invention in detail, it is to be understood that the invention is not limited in its application to the details of operation and to the arrangement of the various aspects in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising.” Thus, use of the term “comprising” indicates that the listed elements are required or mandatory, but that other elements are optional and mayor may not be present. By “consisting of’ is meant including, and limited to, whatever follows the phrase “consisting of.” Thus, the phrase “consisting of” indicates that the listed elements are required or mandatory, and that no other elements may be present. By “consisting essentially of’ is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and mayor may not be present depending upon whether or not they affect the activity or action of the listed elements.

### THE OBJECTS OF THE INVENTION

It is therefore an object of the present invention to provide an easily deployable computer networked system for a communication amongst peers in business and industry to better communicate.

It is an additional object of this invention is to provide such a system which limits individual groupings of peer members to small numbers.

A further object of this invention is to employ software adapted to form a database on peer member expertise as a means for targeting direct questions and polls, to the individual peer group members, most based on input information stored in a database and matched to a question, are most qualified to answer the questions to yield high quality results.

Another object of the invention is to provide means to match members to areas of high interest and/or extensive experience.

It is an additional object of this invention to match members with other members having similar interests and experience.

A further object of the invention is to provide a means for teleconferencing or webcasting.

Yet another object of the invention is to provide a communication tool, such as email, which provides a system identifier for sent email which also may be communicated through members existing email accounts.

A further object of this invention is the provision of an email system which protects the actual and electronic location of members through an interface allowing email communication through choosing of icons which employ a relational database to communicate email sent by sending members.

These, together with other objects and advantages which will become subsequently apparent to those skilled in the art, reside in the details of the system for providing peer group interaction herein and as herein described and claimed, reference being had to the accompanying drawings forming a part thereof.

### DESCRIPTION OF DRAWINGS

FIG. 1 depicts members formed in clusters divided by determined research areas.

FIG. 2 depicts the profile input for members as to employment and interest and experience.

FIG. 3 depicts a mode for choosing poll drafters.

FIG. 4 depicts the drafting and review of polled questions to members of the cluster.

FIG. 5 shows the determination of preferred poll recipients based on experience and interest level.

FIG. 6 shows the distribution of a poll in a typical sequence.

FIG. 7 (4) displays 6 of the 40+ topics for the research area where members select the best description for their respective level of experience and respective interest in each topic.

FIG. 8 (1) displays the topic categories for a research area.

FIG. 9 (2) displays search results when a specific topic is selected.

FIG. 10 (3) displays the results display screen for the 34 peers who self-reported and showing they have a high or very high experience level in the specific topic.

FIG. 11 (5) displays the details available when the name of a listed peer is selected using the provided graphic interface.

FIG. 12 (6) displays the email communication capability of the application when the selection to send a message is made.

FIG. 13a (7) displays a depiction of a graphic interface when a member searches “Peers by Topic,” selected as “Highly Experienced Peers by Topic.”

FIG. 13b (7) displays a depiction of a typical graphic interface communicated to a member when they search “Peers by Topic,” selected as “Highly Interested Peers by Topic.”

FIG. 14 depicts a communicated screen showing the results when selecting a specific topic for peers with high experience, or very high experience. There are 34 peers identified.

FIG. 15 depicts a communicated screen showing the results when selecting the specific topic for peers with high interest, or very high interest. There are 84 peers identified.

FIG. 16 displays a communicated display of the schedule of webcasts which are upcoming for each research area. The topic, feature person and company, whether or not attending, and number of registered attendees are also displayed.

FIG. 17a displays the view of the communicated screen with webcast information including title, description, and member lead.

FIG. 17b displays the view of the screen communicated to members of registered attendees when selecting the webcast for the research area.

FIG. 18 12 displays a screen communicated showing the detailed view of information of a registered member. Note that the last name is not displayed, nor is a phone number or email address displayed; however, there is a link to send a message.

FIG. 19 depicts a communicated screen providing the listing of recent webcast results for the research area, Shared Services. The number in the right column is the number of attendees, which is linked to the pictures and summary profile information, similar to what is displayed in FIG. 17.

FIG. 20 14 depicts a screen communicated with the webcast information for a recorded webcast. The member can select to view the recording, or download the presentation. Members selecting to view, who are not already listed as one of the attendees, will cause the system to add their contact details to the list of attendees for subsequent viewers of the screen.

FIG. 21 15 displays a view of a communicated screen showing the text of a peer mail message where a member is following up with another member to ask a question and discuss their response to a poll.

FIG. 22 16 displays some of the visibility each peer has on the communicated home page for a research area and the communicated display of the number of peers in the research area, the number of peers in the research area who are from a member's own company, and the number of connections each respective peer has in the research area. The screen is customized for each viewing member.

### DETAILED DESCRIPTION OF THE PREFERRED EMBODIMENTS OF THE INVENTION

The system 10 employs software adapted to the task, and running on a networked computer communicating with individual peer members, of groupings of peers, on their remote computers through a server providing an interface therebetween.

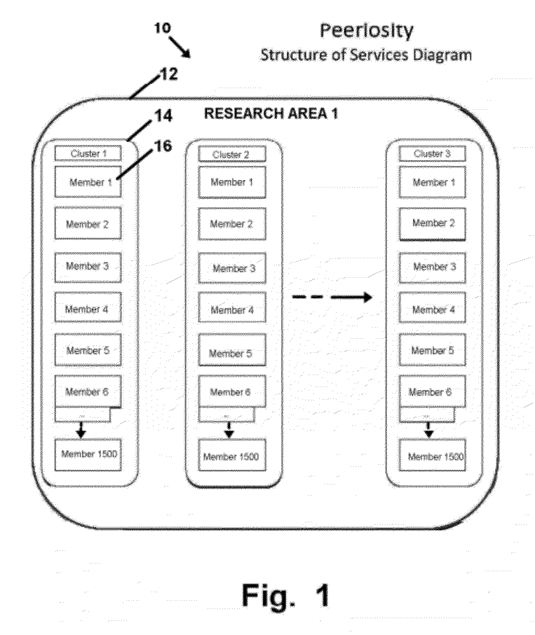

As seen in FIG. 1, the system 10 herein employing software adapted to the task, creates individual research areas 12 having one or a plurality of clusters 14 in each designated research area 12. The clusters 14 are populated with a plurality of peer members 16. It should be noted that the term member and user are employed interchangeably herein.

The clusters are limited in the number of peer members 16 who may be associated with individual clusters 14 to less than 1,500 members 16. Each research area 12 is determined by job type for instance accountants, human resources, administrators of a particular type. Members 16 of clusters 14 would be employees of a company who work in a job identified as associated with the research area 12. This clustering system of a limited number of members 16 all of whom are identified as having a job associated with within the scope of the research area 12 provides a means to insure that polls and other information interchanged between the members 16 and clusters 14 are on topics which are highly related to the job interests of the members 16.

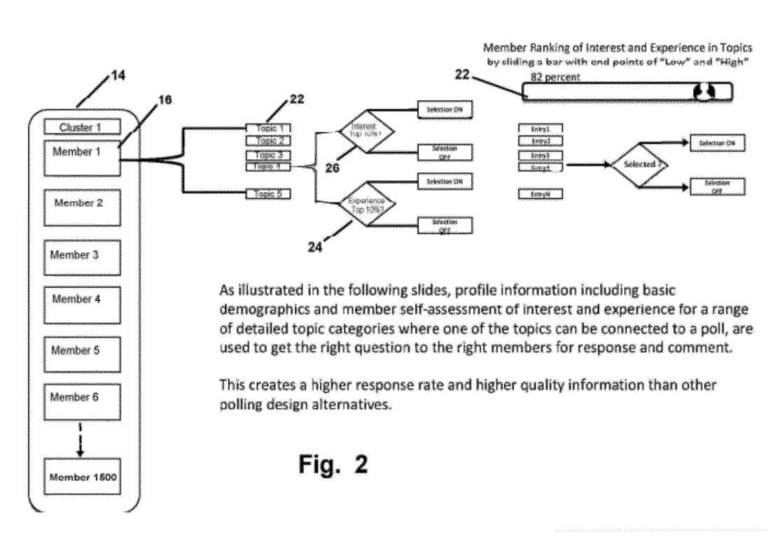

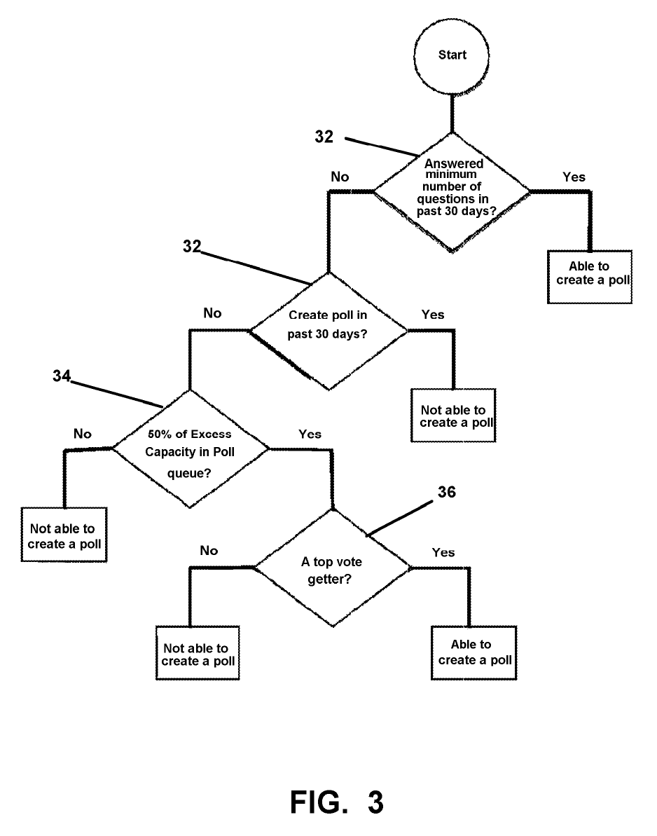

Determining which research area 12 each member 16 will be associated within the database of the software for the system is accomplished through a member profiling system of FIG. 2. During an initial sign up to the system 10 each member 16 are presented with input forms electronically with input fields for the member 16 to designate at least their job type, and optionally their industry, company size, and other information to ascertain a cluster 14 for the member 16 which will have other cluster members who have a similar job type and other factors determined to be similar to all the members 16 of a cluster 14. Cluster 14 membership is limited in size with the current preferred maximum of 1,500 members 16. Each cluster 14 is filled with members 16 on a first come first serve basis.

In FIG. 2 is seen how an interest and experience profile of each member 16 is discerned and stored in the database and associated with each member based on responses. During an initial sign up, and during updates thereafter, members 16 associated in the database employed by the software with each respective cluster 14, are polled for their respective interest level in one or a plurality of topics presented to them by the software, and their experience level, with each topic presented. Members 16 provide interest level on a sliding scale 20 to a range of topics 22 presented. Other mean for matching members 16 with topics of interest and experience are described shortly below.

Software adapted to the task determines the members 16 of each cluster 14 with the highest experience level 24 and highest interest level 26 for each topic 22 and maintains that information in the database. This stored information is later employed to direct polls or questions to those members 16 with the highest interest level 26 and highest experience level 24 in a given cluster 14 for a question topic as a means to create a higher response rate and higher quality answer.

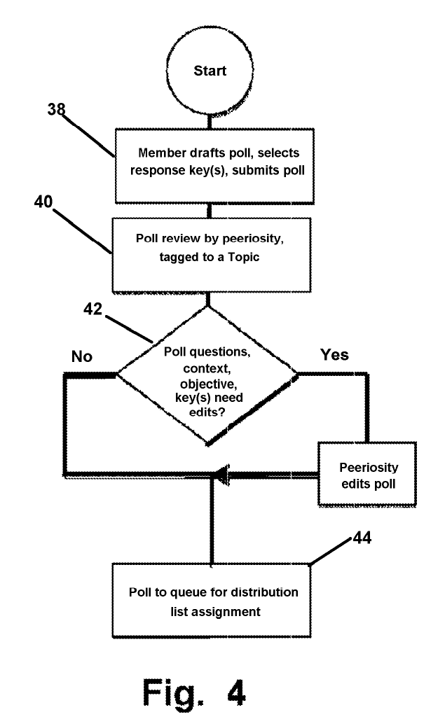

Once members 16 are chosen to draft a poll, the poll is determined in FIG. 4. Here one or a plurality of eligible members 16 drafts the poll and responses 38 which then are reviewed 40 by an employee of the provider of the system. If the poll questions, context, object, and answer keys, are determined acceptable 42 by the employee of the system the poll is sent for distribution through the system administrator providing the system 10 herein.

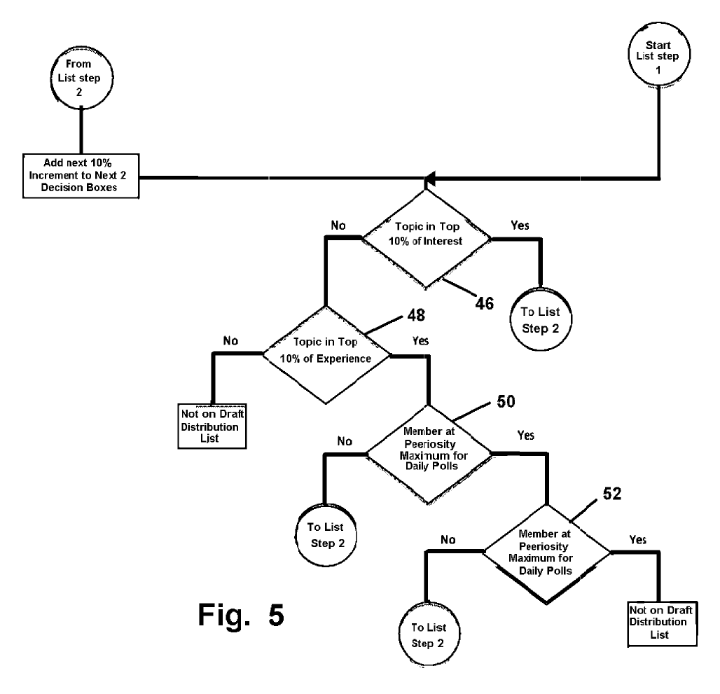

As shown in FIG. 5, the administrator assigns a distribution list for the poll to members 16 in the cluster 14 based on the members 16 original inputs as to interest levels on the topic 46 and the members 16 experience level 50 in the topic and whether the chosen members have exceeded a maximum number of polls 52.

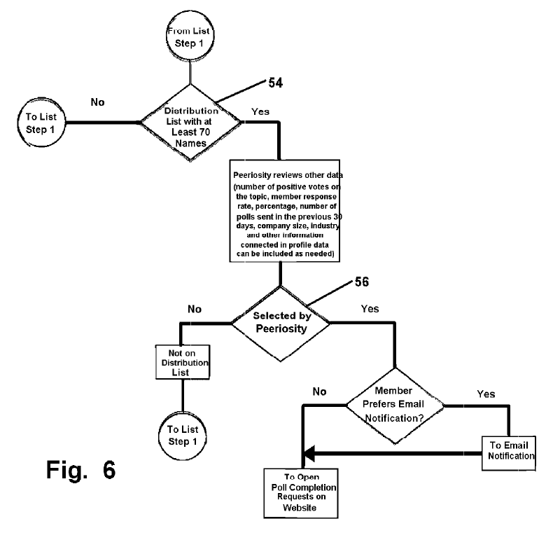

Thereafter as in FIG. 6, the system administrator can pick the chosen members 16 from FIG. 5, and communicate the poll question to the members 16 who are determined using selection criteria in the relational database 54b, as the most likely to respond 56 based on interest and experience. As noted, a poll may also be taken of the responding members 16 as to what they thought about the topic and question.

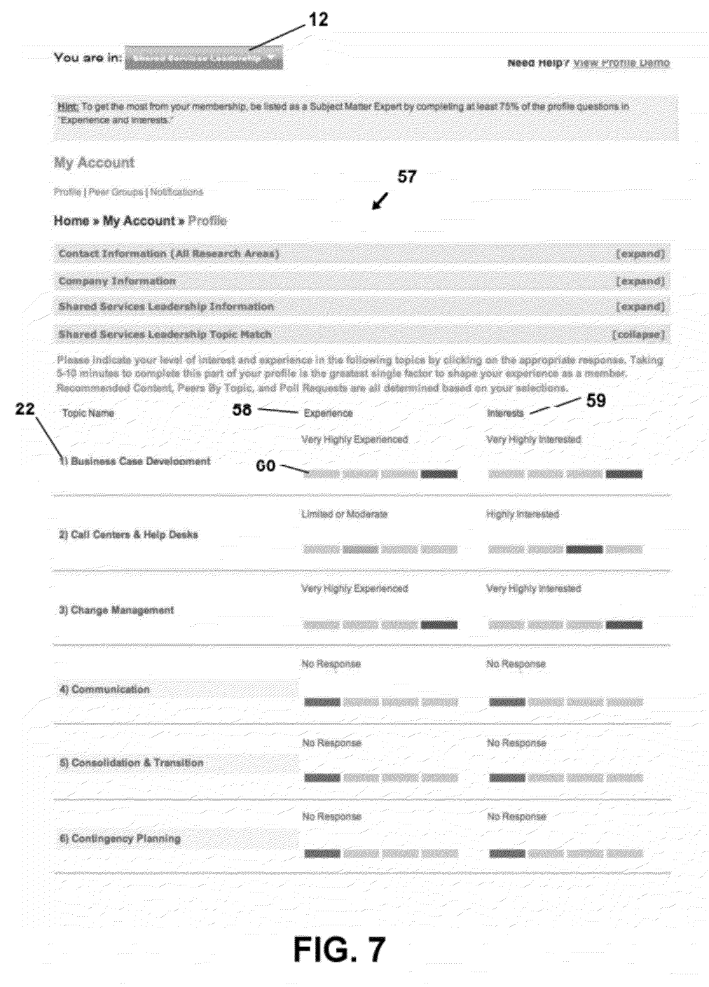

The system maintains detailed profile information on respective member experience which is derived when a member 16, and many others in this research area 12, responded to system-posed questions, to indicate their level of experience 58, and their level of interest 59 relative to each of the topics 22 that are used to define the research area 12. In the profile completion section 57 communicated to members 16 by the system provider as graphic interface screens, for each research area, members 16 complete response selections 60 to indicate a Topic Match for the listed topics 22 that define the research area 12 (FIG. 7).

Selection options 60 communicated in the graphic interface allow members 16 to input of “No Response,” or a member derived interest level of “Limited or Moderate,” “High,” or “Very High” so as to form a relational database relating each member's interest level relative to respective research areas 12 and a matching subsequently of members 16 to research areas 12 identified as high in interest.

Members 16 who complete a system predetermined portion, currently at least 75% of their profile 57, are identified in the listing of peers as “Subject Matter Experts.” Members 16 who fail to complete the predetermined minimum portion of their profile 57, are identified in the listing of peers at “Observers.”

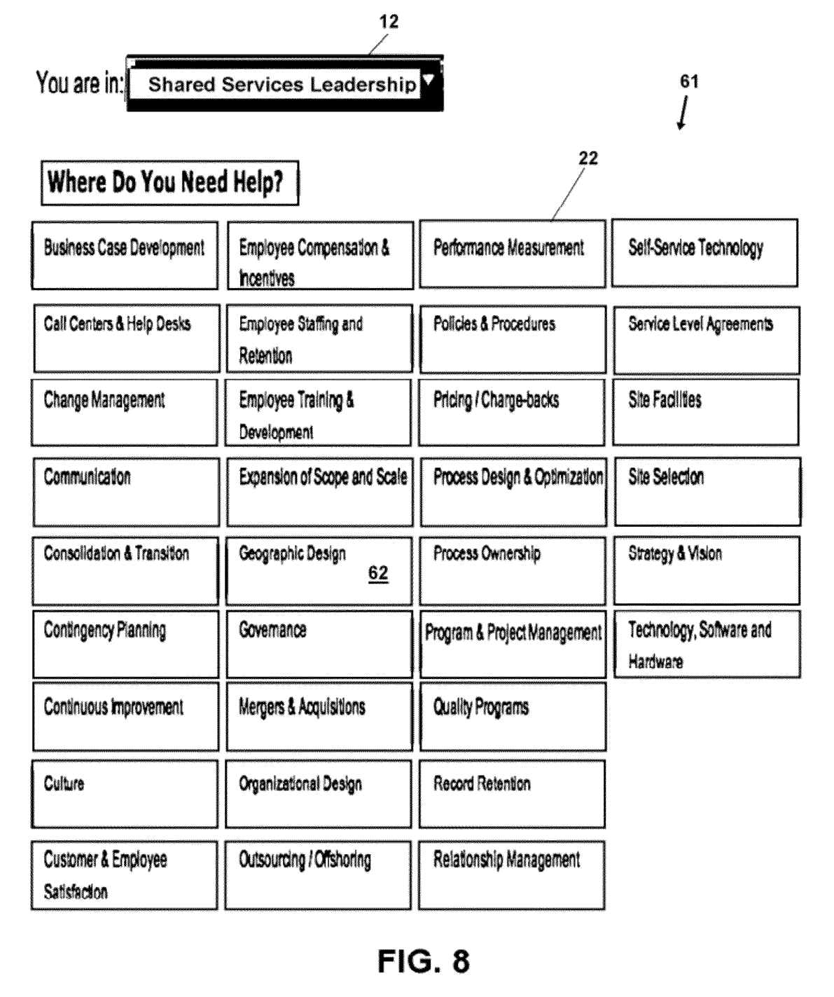

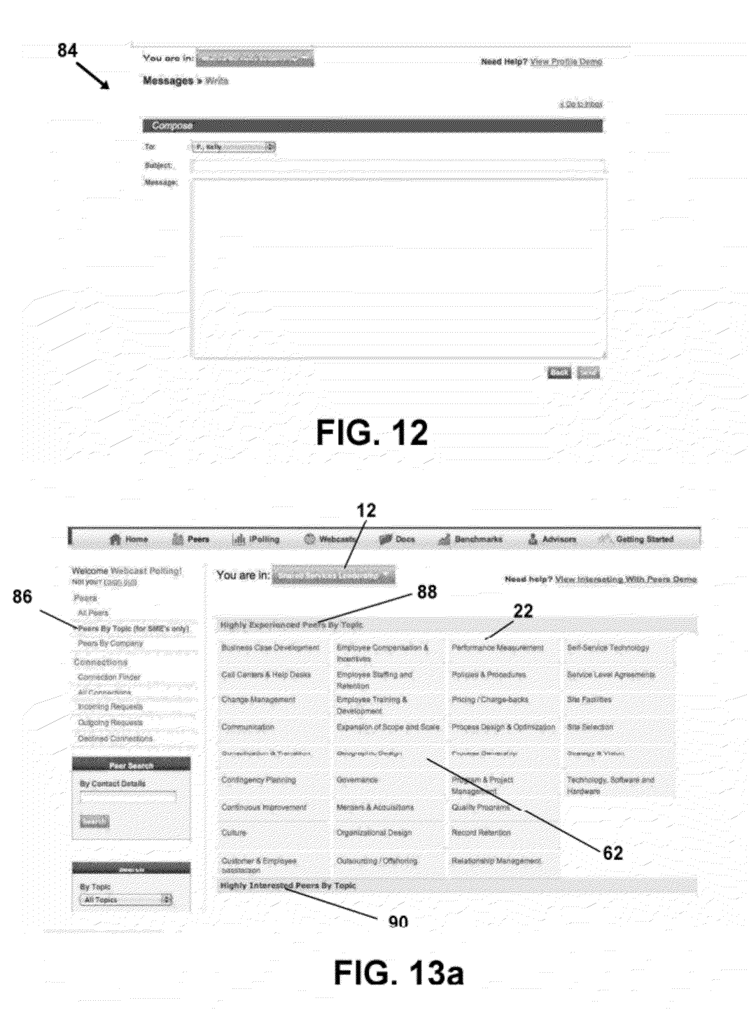

Other means for matching members 16 with other members 16 and a range of topics 22, are additionally provided. Again, each research area 12, is segmented into separate topics 22, which are used to define the research area 12. In FIG. 8, a member 16 is provided with a screen having a list 61 of topics 22, for relating to a research area 12. In the depicted screen of FIG. 12, an example is given called a “Shared Services Leadership” research area 12. The member 16 may have questions that relate to a specific topic 62 (“Geographic Design” is chosen merely as an example) so they may select the topic 62 box of the communicated screen via icon-based interaction, to request a system communication of peers identified by the relational database as relating with the specific topic 62.

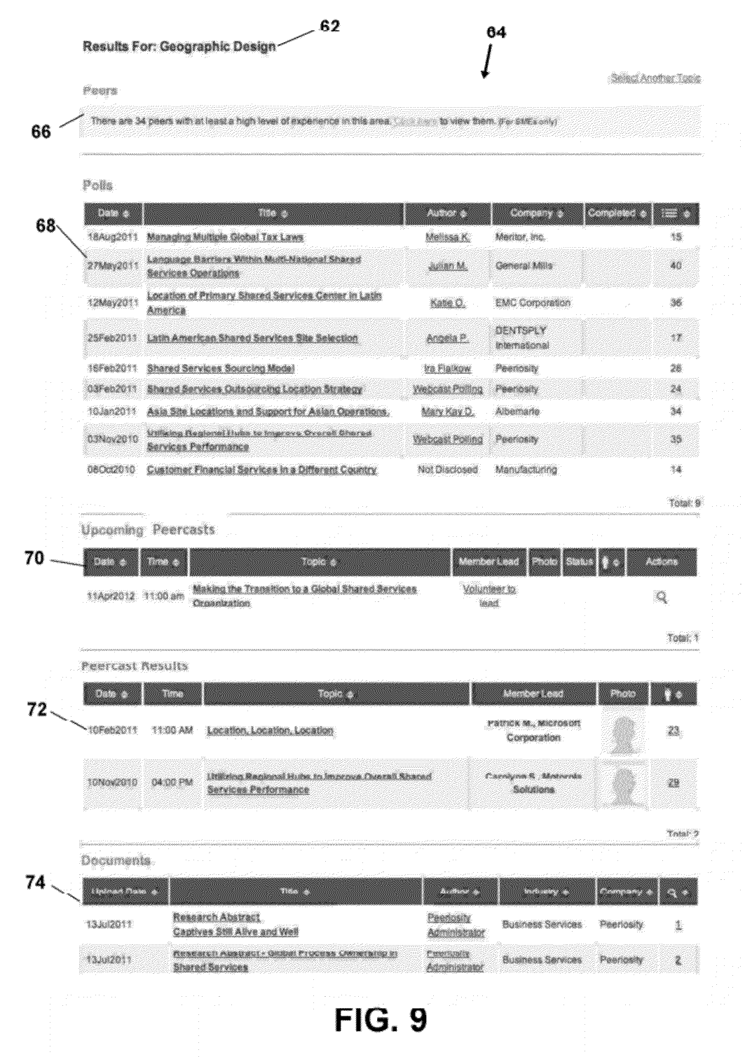

FIG. 9 shows the listing of communicated results 64 for the member inquiry about the specific topic 62, indicating that there are 34 peers 66, with at least a high level of interest in the topic 62. In addition is listed, member 16 accessible content information including results from member polls 68, upcoming webcasts 70 and results from webcasts 72 which have been conducted, and documents contributed from peers 74.

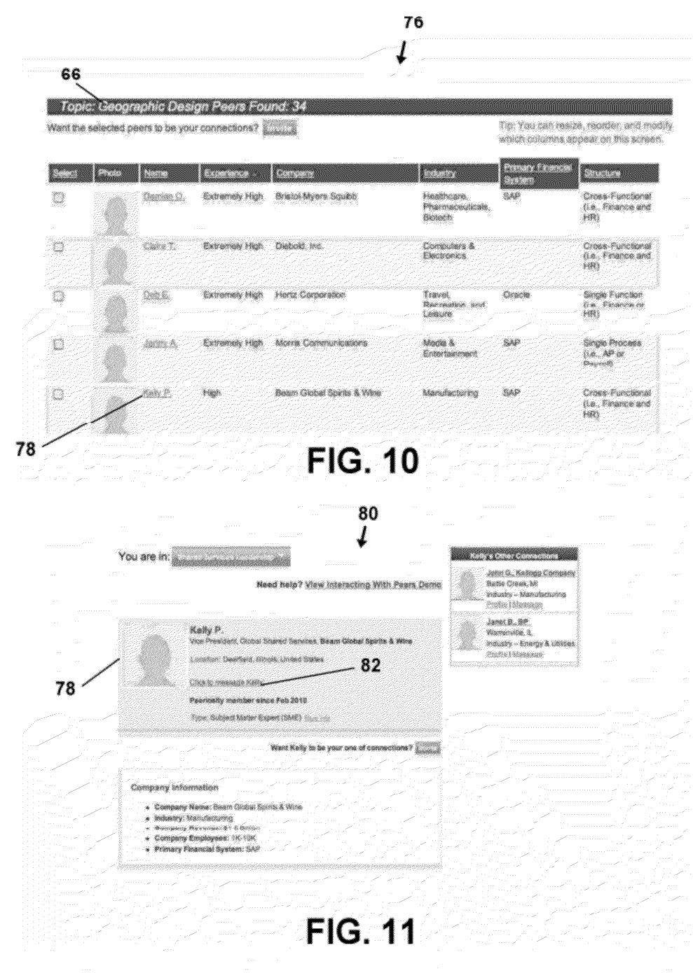

FIG. 10 shows the results 76 the system communicated to the member 16 when they select the link to provide information about the 34 peers 66, with at least a high level of interest. Detailed is the provided screen listing of the peers 66 with profile information including a peer name, their experience, company, industry, and other pertinent peer profile information.

Unlike other research services where users or members 16 can use search capabilities to find content on a particular topic, the system herein employs a relational database which allows members 16 to search to find other members 16 or peers, with experience and/or high interest level in the topic. When the member 16 reviews the communicated screen-listing of peers as shown in FIG. 10, they may also be interested in contacting one or more of them. By selecting the link for a specific peer 78, where their name or identifying handle is hotlinked, information about the peer 78 chosen is communicated for screen viewing.

FIG. 11 depicts a view of the peer information 80 screen. The member 16 reviewing this screen is able to use hotlinks on the screen to invite the peer 78 to be a connection, wherein the system will communicate by email to the chosen peer 78 the request to which the peer 78 may reply. Or, if the member 16 reviewing the screen prefers, they can select the provided hotlink to directly message the peer 82 rather then to invite the connection. This allows members 16 who may be a little timid a means to receive a potential peer 78 positive reply before attempting a direct communication by email.

As shown in FIG. 12, an input screen is provided the member 16, without disclosing the peer's direct contact details. Using the provided input screen, the member 16 is able to create a custom message 84. Once completed the message is communicated through the system email server, which maintains a relational database of members 16 and their contact information, and the system routes the email message directly to the peer's chosen home or work email address. A discernible system origination is sent with the email whereby the recipient may easily determine the source of the email is from the system.

The member 16 may also be interested in reviewing more information about one or a plurality of peers 78 in the research area 12 screen interface. Using the communicated graphic interface which links to a system relational database, the member 16 is able to search for peers 78 based on different criteria. This criteria may include one or a combination of user-chooseable criteria including, peers 78 matching the inquiring member's 16 company information, a listing of peers 78 in each research area, or in each research area by company, where all members 16 are listed with their respective company's name.

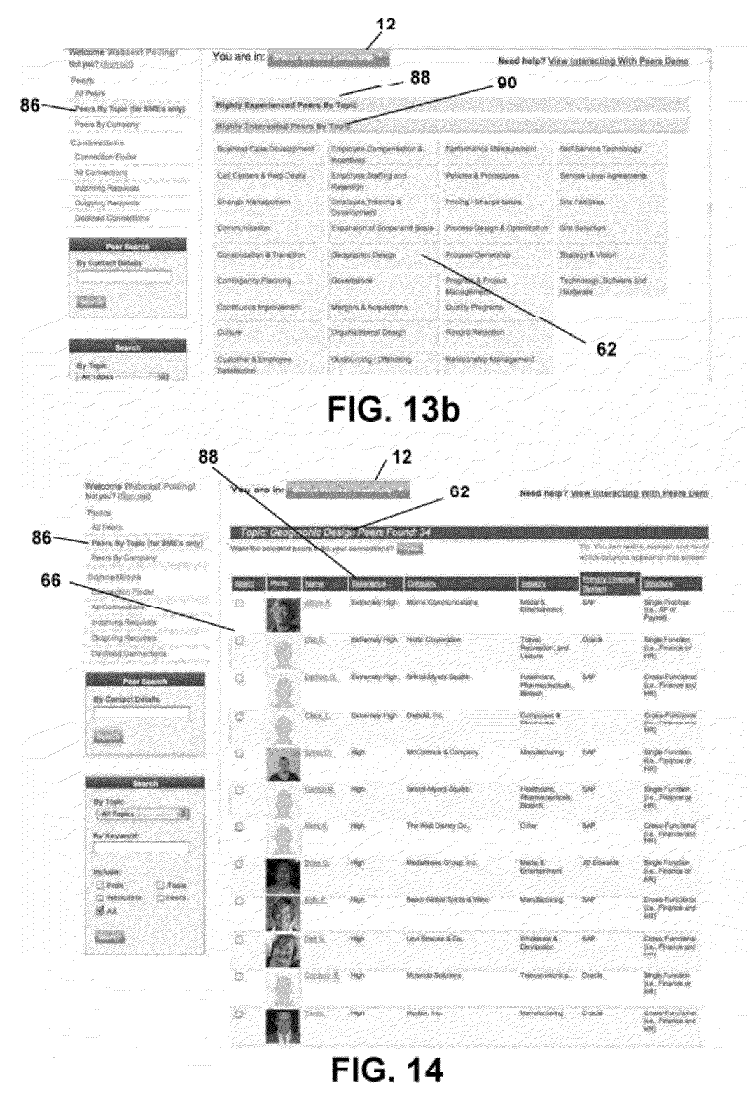

The system will provide graphic interface screens allowing the member 16 to search for, and select, peers 78 by topic interest(for SME's only) 86. The member 16 can search and be provided means to identify the peers 78 by relative interest level in a particular topic. Thus a member can use the search interface to identify peers 78 who either have “high experience” 88 (FIG. 13a) or “high interest” 90 (FIG. 13b) in each topic 22 which are employed to define the research area 12.

As an example as shown, using this provided graphic interface to search and identify peers 78, when the user selects the topic 62 under “highly experienced” 88, the same list of 34 (thirty four) peers 66 is provided in the results displayed (FIG. 14) as was displayed in FIG. 9.

In addition to identifying experienced peers 66, the member 16 may also have an interest in determining peers 78 who have high interest 90 in the topic 62, regardless of their relative experience level as youth and exuberance can often be sought rather than years of experience. As illustrated in FIG. 15, when employing the provided graphic interface to search using this parameter, the member 16 is provided results showing there are 84 (eighty four) peers 92, who have either a high or very high interest 90 in the topic 62, again Geographic Design chosen as an example. This result is to be expected from the relational database providing the search. This is because each research area 12 includes only practitioners who are professionals with job responsibilities that related to the topics 22, in the research area 12. Thus it's likely that there will be a greater number of members 16 listed with interest in a topic, than there are members 16 who are listed with experience in the topic.

Should the member 16 decide to contact a peer 78 identified in the results screen, it is important that the member 16 is confident that the peer 78 listed is still in the identified job role, and still an active system member 16. To insure only active members 16 are identified, identified peers listed in search results are displayed only when a peer 78 has logged into the system within a predetermined period, such as 90 days. Peers 78 identified in the relational database who have not logged in for over the defined period of time, will be left of the listing of results displayed.

In addition to participating in polling, the member 16 can create questions for peers 78 which are intelligently communicated by the system to peers 78 for a response with results posted real-time. The member 16 may also participate in regular webcasts, which are virtual meeting of peers 78 in a given research area. Such webcasts may feature a brief case-study from a peer's company, or from other members with similar research areas of interest in respective user profiles, as a launching point for an interactive discussion with other peers who are registered in the research area. The webcast discussion professionally moderated and guided by system monitors or assigned members 16.

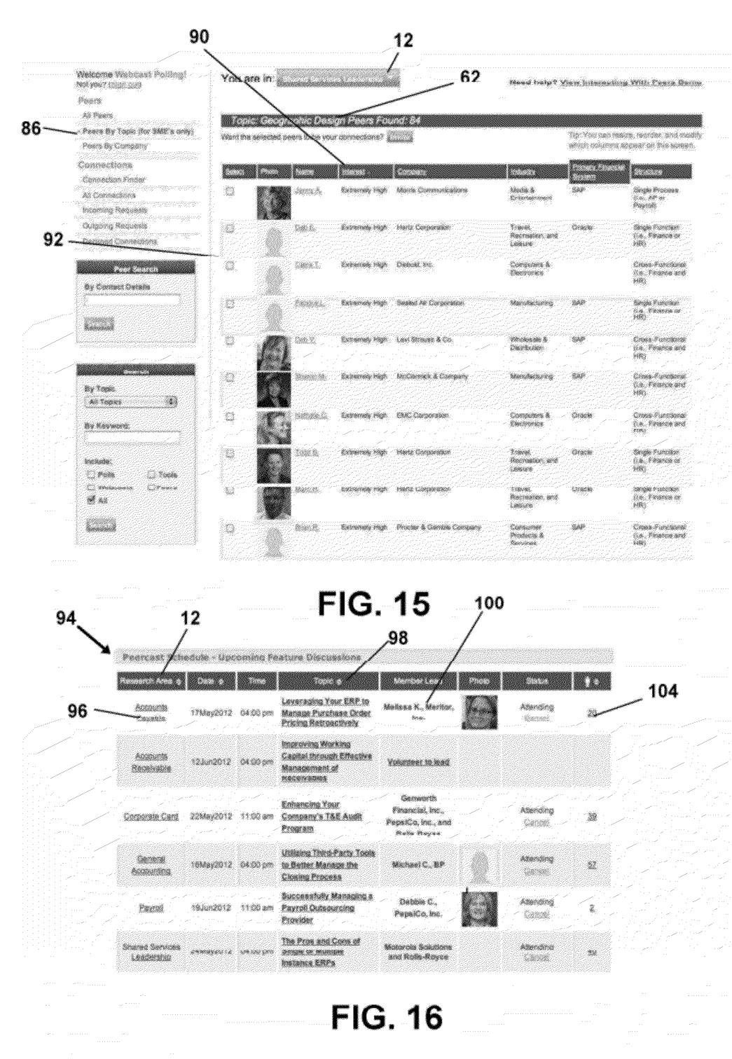

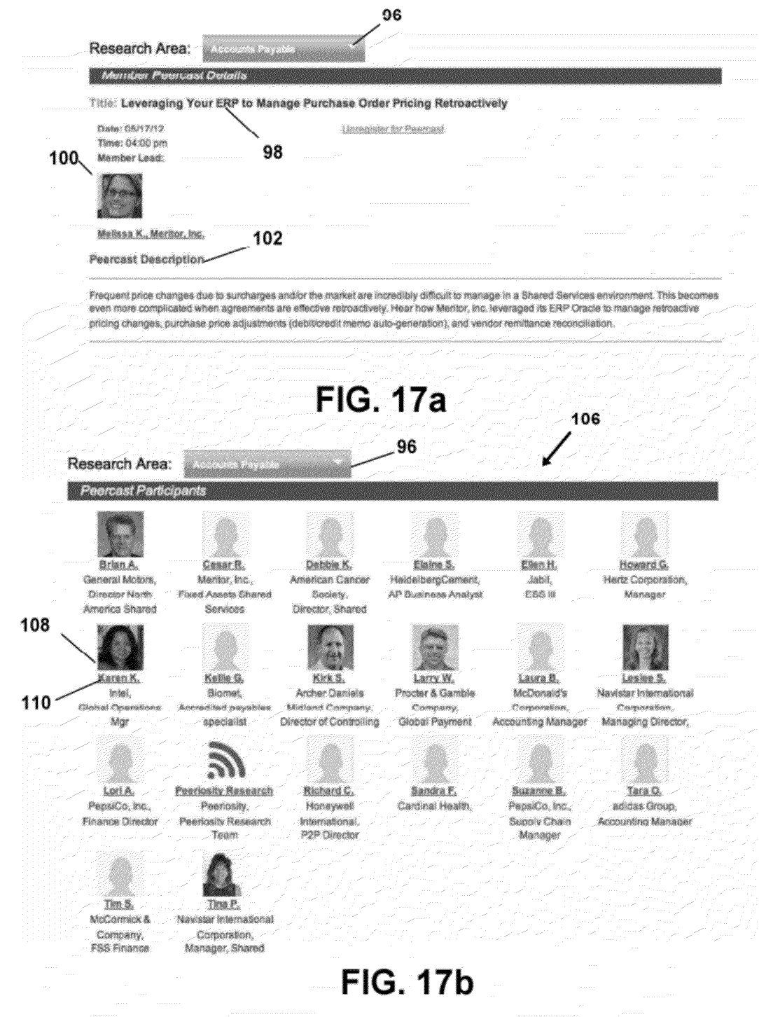

As illustrated in FIG. 16, the member 16 can be provided with screens allowing them to quickly scan the listing 94 of upcoming webcasts for each research area where the member 16 is registered. By selecting on the title 96, for the upcoming webcast in a certain topic 98, as an example ‘Accounts Payable’ is chosen, the member 16 can view more information 102 about the discussion topic 98 and member lead 100 (FIG. 17a). Further, by selecting the link to communicate the number of confirmed attending peers 104, the member 16 is communicated indica where they may review information 106 about the peers 78 who are already registered to attend (FIG. 17b) the future webcast.

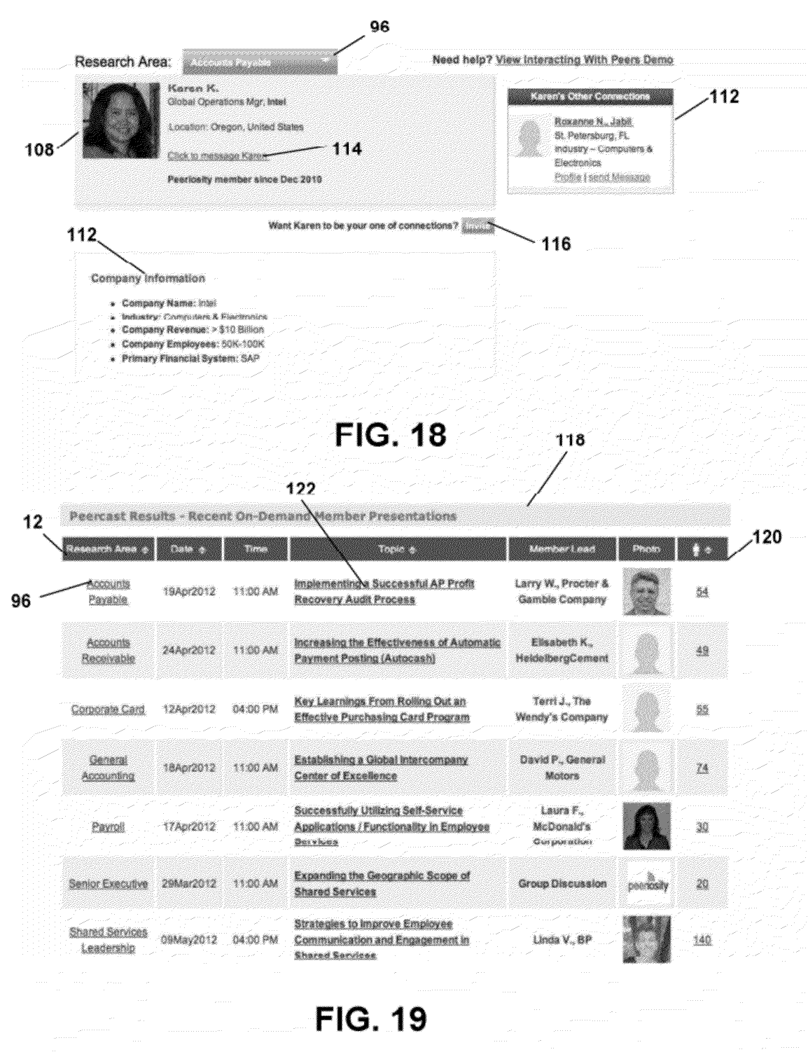

The member 16 may be interested in a particular peer 108, for example Karen from a company Intel, is attending the webcast. The member 16, by then selecting her name 110 on the displayed graphic interface, may view additional profile details 112 about the chosen peer 108 (such as company details as well as the peer's 108 connections). Using the graphic interface the member 16 may also choose to send the peer 78 an email message 114, or may request the system to send the chosen peer 78 an invitation the chosen peer 78 to be a connection 116 (FIG. 18) of the member 16. Email and invitations are sent to the chosen peer 78 by the system email server using stored contact information eliminating the need for the member 16 to have such information.

The member 16 may also be provided a graphic interface allowing them to view prior recorded webcasts. This may be done by providing a screen listing 118 of all research areas 12, where the member 16 participates (FIG. 19) or separately by a screen listing by research area 12.

The member 16 can employ the provided screen listings and icon or text links to select on the request to view the listing of attendees, which may be very helpful if the member 16 wants to refresh their memory of who was on the call or webcast.

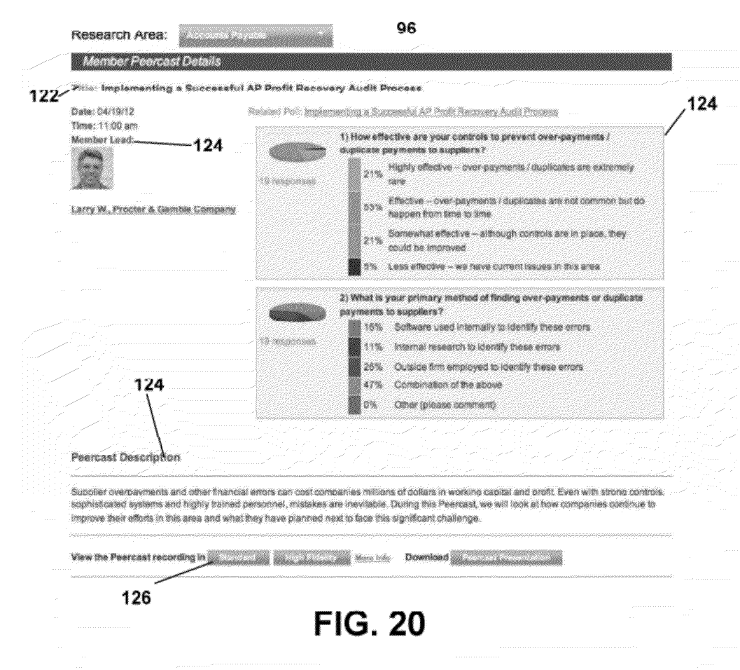

Should a member 16 have been unable to attend the discussion or webcast, a selection on the provided graphic interface of the title 122 of the webcast, allows the member 16 one or a combination of a viewing of the presentation material for the webcast, a viewing of the webcast information 124, and/or a communication of sound from the webcast to listen to the recording thereof, and/or a communication of a video 126 of the webcast (FIG. 20). Because the member 16 is provided the graphic interface with a listing of attendees, following up with peers 78 to discuss comments made on the webcast, will be very easy. By clicking upon or otherwise choosing a particular listed attendee, the system will automatically use the email server to communicate a message, without the member 16 choosing to send the message knowing the destination address.

As noted, because it is likely that members 16 receive many emails daily, it is also likely they must filter and screen and even incoming messages, in order to handle the barrage of messages that arrive daily. However in the system herein, when one member 16 message reaches other peer 78, a discernable identifier is carried with the message. This allows receiving members 16 to easily and immediately identify an incoming message from the system, thereby providing means for members 16 to recognize an incoming email as originating from another member 16 or peer 78. As such, the message is much less likely to be ignored, filtered, deleted inadvertently, or filtered to spam as a message from a name or address that isn't recognized.

Responding to peer or member email is also made easy by the system herein. Emails originating from the system server will carry a text or html link, which automatically logs a member 16 into the mail server to send a response. Thus members 16 wishing to generate an email, in response to another peer or member email, are immediately entered into the systems email server without having to enter a user ID and/or password information. This entry to the system may be limited to the email area thereby making sure that third parties may not enter other system areas.

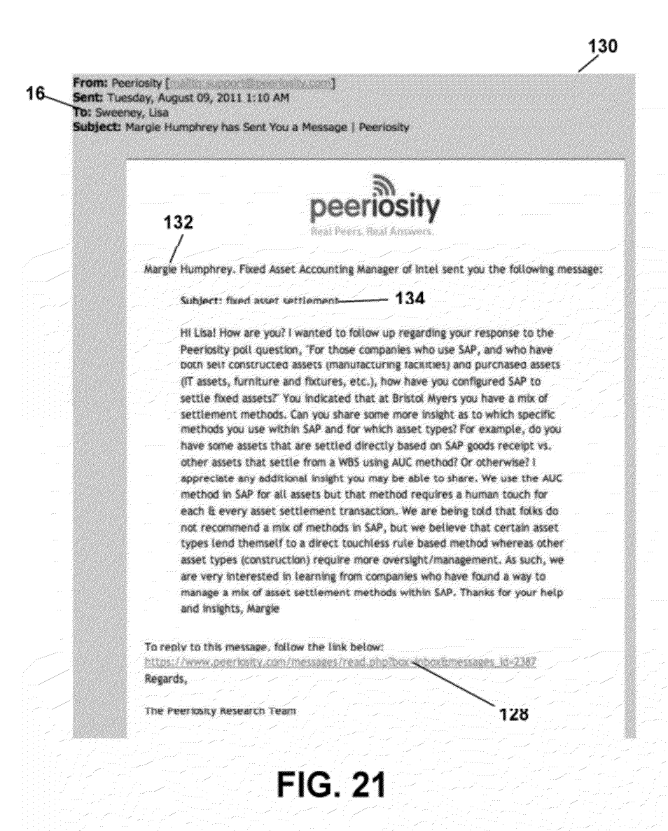

FIG. 21 illustrates a message 130 communicated to a sending member's peer 132 in a research area. Again the example of ‘General Accounting’ research area is shown, which includes topics 134 related to a work process, in the example given as ‘Fixed Assets’. In this example, per a request from member 16 Margie Humphrey (peer 132), a connection request to Lisa Sweeney (member 16), is sent from the system, using the system's email server. Lisa 16 can read the message 130, and by selecting the provided html or text or other communicated link 128 in the message, Lisa may access the system mail server and create a reply to Margie 132.

Using a provided graphic interface, a member 16 can also select multiple peers 78, and request the system to communicate an invite to each be a connection of the sending member 16. Establishing connections requires an invitation which must be acknowledged by the recipient as accepted. This requirement for user or peer acknowledgment provides additional means for the system to manage member 16 interaction and insure to all members 16 their privacy is protected thereby encouraging use. Only with a receiving peer's acknowledgment of accepting an invitation will the sending member 16 be allowed to view more details about the other peer or member 16, including information stored in the relational database concerning top areas of experience and interest, a peer or member's full name, and their off-system email address and phone number.

The member 16 may have peers 78 at the member's company who are also members 16 of the system. For these peers 78, the system employing software adapted to the task, will discern the company relationship and allow such same-company members 16 full contact information. In other words, members 16 who work for the same company, are treated by the system as being connections, without having to make connection requests and have them accepted. This mode is particularly helpful for the member 16, since they may work for a large global company with employees from around the world with whom the member 16 may not be personally acquainted.

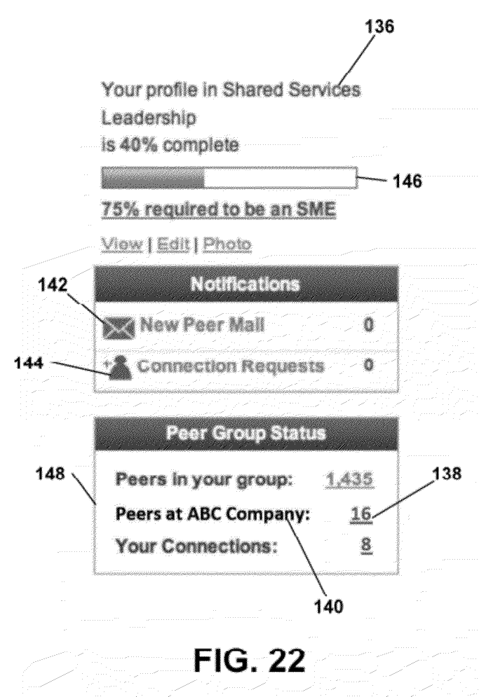

To make it even easier for the member 16 to discern fellow company members 16, a graphic interface, for example the home page 136 (FIG. 22), of each research area, may display member specific viewable information as to the number of peers 138, or members who also originate from the viewing member's 16 company 140, who are also active in this research area.

Using software adapted to the task of tracking individual members 16 and relating their respective company to that of other system members 16, the system would customize this page relative to each member 16 and their company. This will result in the displaying of member-specific viewable information when a member 16 visits a respective member home page 136. The member homepage 136 will also display additional information such as incoming mail 142, peer connection requests 144, percentage of profile completion 146, and other pertinent information such as group status 148.

The foregoing has outlined rather broadly the more pertinent and important features of the peer group communication system herein in order that the detailed description of the invention that follows may be better understood so that the present contribution to the art may be more fully appreciated. It should be appreciated by those skilled in the art, that the conception and the disclosed specific embodiments herein, may of course be readily utilized as a basis for providing other peer group business social networking services for subscribers and authorized users for carrying out the same purposes of the present invention. It should also be realized by those skilled in the art that such equivalent systems and methods are considered within the spirit and scope of the invention as set forth herein.

What is claimed is:

1. A method for assembling and managing communication between members of a business peer group social network employing software and a relational database running on a computer, in a network communication through a server with remote computing devices of members, comprising the steps of:
enrolling members to said peer group social network through communication over said network of a profile graphic interface allowing members to input profile data into fields;
employing said profile data input by said members into fields, to assemble a respective member profile, for each said member;
assigning a screen name to each said respective member relating to their respective profile;
storing a respective member profile for all members of said peer group social network, in a relational database;
ascertaining job type, based on said profile data, for each said member, as part of their respective member profile;
employing computer software adapted to the task of maintaining a database of a plurality of respective research areas, each said research area defined by a plurality of topics;
for respective research areas, ascertained of interest to respective members, communicating with said members over said network to ascertain a respective interest level of each said member, in each of said plurality of topics defining a said research area of interest;
for respective research areas, ascertained of interest to respective members, communicating with said members over said network to ascertain a respective level of expertise for each said topic defining a said research area of interest;
forming a database association for each said member to a cluster of said members, each said member of said cluster having a related said job type;
providing a computer interface over said network to a requesting member, which functions as a means to identify other said members who are related to a particular said research area of interest to said requesting member;
for each respective said topic relating said research area of interest, providing a computer interface over said network to a requesting member, which functions to provide a means for said requesting member to identify one or both of a respective level of experience and a respective level of interest of each respective said other of said members, in each respective said topic, to thereby ascertain a match of one or a plurality of said other of said members to requirements of said inquiring user; and
providing means for an electronic communication between a said requesting member and any of said other of said members determined as a said match.

2. The method for assembling and managing communication between members of a business peer group social network of claim 1 additionally comprising the step of:
providing only the respective screen names in said electronic communication between said requesting member and said other of said members during any such electronic communication as a means to maintain anonymity for each said member.

3. The method for assembling and managing communication between members of a business peer group social network of claim 1 additionally comprising the step of:
determining a set of said members having a commonality of said area of interest;
choosing one or a plurality of said members to draft a poll regarding one of said topics related to said area of interest;
distributing said poll question to a subset of said members having determined factors likely to respond to said poll;
said determined factor being said members with respective said profiles having a profile having a respective said interest level and respective said level of expertise in said topic of said poll, at a highest level relative to all members of said cluster;
collecting answers to said poll; and
distributing said answers to said poll to all said members of said cluster.

4. The method for assembling and managing communication between members of a business peer group social network of claim 2 additionally comprising the step of:
determining a set of said members having a commonality of said area of interest;
choosing one or a plurality of said members to draft a poll regarding one of said topics related to said area of interest;
distributing said poll question to a subset of said members having determined factors likely to respond to said poll;
said determined factor being said members with respective said profiles having a profile having a respective said interest level and respective said level of expertise in said topic of said poll, at a highest level relative to all members of said cluster;
collecting answers to said poll; and
distributing said answers to said poll to all said members of said cluster.

5. The method for assembling and managing communication between members of a business peer group social network of claim 1 additionally comprising the step of:
providing a system identifier communicated with any said electronic communication between a said requesting member to any of said other of said members determined as a said match, said system identifier providing means for said other of said members to determine the message originated from the means for electronic communication of said business peer group social network.

6. The method for assembling and managing communication between members of a business peer group social network of claim 2 additionally comprising the step of:
providing a system identifier communicated with any said electronic communication between a said requesting member to any of said other of said members determined as a said match, said system identifier providing means for said other of said members to determine the message originated from the means for electronic communication of said business peer group social network.

7. The method for assembling and managing communication between members of a business peer group social network of claim 3 additionally comprising the step of:
providing a system identifier communicated with any said electronic communication between a said requesting member to any of said other of said members determined as a said match, said system identifier providing means for said other of said members to determine the message originated from the means for electronic communication of said business peer group social network.

8. The method for assembling and managing communication between members of a business peer group social network of claim 4 additionally comprising the step of:
providing a system identifier communicated with any said electronic communication between a said requesting member to any of said other of said members determined as a said match, said system identifier providing means for said other of said members to determine the message originated from the means for electronic communication of said business peer group social network.

9. The method for assembling and managing communication between members of a business peer group social network of claim 1 additionally comprising the step of:
providing access for members having common said research areas or said topics of interest of a common said research area, to scheduled webcasts;
allowing said members to opt into attending any such webcast;
during any such webcast, communicating at least live audio of any speaking member of said webast, to the other respective members attending said webcast, and;
communicating to the video display of said members attending any such webcast in real time, or in a subsequent viewing of said webcast, a hotlink to send a said electronic communication to said speaking member.

10. The method for assembling and managing communication between members of a business peer group social network of claim 5 additionally comprising the step of:
providing access for members having common said research areas or said topics of interest of a common said research area, to scheduled webcasts;
allowing said members to opt into attending any such webcast;
during any such webcast, communicating at least live audio of any speaking member of said webast, to the other respective members attending said webcast, and;
communicating to the video display of said members attending any such webcast in real time, or in a subsequent viewing of said webcast, a hotlink to send a said electronic communication to said speaking member.

11. The method for assembling and managing communication between members of a business peer group social network of claim 6 additionally comprising the step of:
providing access for members having common said research areas or said topics of interest of a common said research area, to scheduled webcasts;
allowing said members to opt into attending any such webcast;
during any such webcast, communicating at least live audio of any speaking member of said webast, to the other respective members attending said webcast, and;
communicating to the video display of said members attending any such webcast in real time, or in a subsequent viewing of said webcast, a hotlink to send a said electronic communication to said speaking member.

12. The method for assembling and managing communication between members of a business peer group social network of claim 7 additionally comprising the step of:
providing access for members having common said research areas or said topics of interest of a common said research area, to scheduled webcasts;
allowing said members to opt into attending any such webcast;
during any such webcast, communicating at least live audio of any speaking member of said webast, to the other respective members attending said webcast, and;
communicating to the video display of said members attending any such webcast in real time, or in a subsequent viewing of said webcast, a hotlink to send a said electronic communication to said speaking member.

13. The method for assembling and managing communication between members of a business peer group social network of claim 8 additionally comprising the step of:
providing access for members having common said research areas or said topics of interest of a common said research area, to scheduled webcasts;
allowing said members to opt into attending any such webcast;
during any such webcast, communicating at least live audio of any speaking member of said webast, to the other respective members attending said webcast, and;
communicating to the video display of said members attending any such webcast in real time, or in a subsequent viewing of said webcast, a hotlink to send a said electronic communication to said speaking member.
